(19) United States
(12) Patent Application Publication
(10) Pub. No.: US 2023/0275684 A1
(43) Pub. Date: Aug. 31, 2023

(54) INTEGRATED WIRELESS SYSTEMS

(71) Applicant: Hewlett-Packard Development Company, L.P., Spring, TX (US)

(72) Inventors: Huai-Yung Yen, Taipei City (TW); Cheng-Fang LIN, Taipei City (TW); Ren-Hao CHEN, Taipei City (TW); Grace TUNG, Taipei City (TW); Ray LIN, Taipei City (TW)

(73) Assignee: Hewlett-Packard Development Company, L.P., Spring, TX (US)

(21) Appl. No.: 18/006,838

(22) PCT Filed: Jul. 31, 2020
(86) PCT No.: PCT/US2020/044662

§ 371 Date: Jan. 25, 2023

(51) Int. Cl. H04L 1/00; H04B 1/401

(52) U.S. Cl. CPC H04L 1/0003; H04B 1/401

(57) ABSTRACT

Techniques for establishing a wireless connection in a computing device are described. In an example, the computing device includes an integrated wireless system having multiple wireless communication modules, where the multiple wireless modules include a first wireless communication module housed outside a component housing of the computing device and a second wireless communication module housed within the component housing. In operation, switching may be performed between the first wireless communication module and the second wireless communication module based on their respective modulation and coding scheme (MCS) indexes to select a wireless communication module for establishment of the wireless connection.

### BACKGROUND

Computing devices include multiple communication modules that facilitate sharing of data with other devices. Selection and usage of a communication module from amongst the multiple communication modules varies based on a type of communication interface to be established and desired performance. For instance, in a situation where higher reliability and throughput is desired over scalability, a wired communication module may be used. On the other hand, in a situation where scalability is desired, a wireless communication module may be selected.

### BRIEF DESCRIPTION OF DRAWINGS

The detailed description is provided with reference to the accompanying figures, wherein:

FIG. 1 illustrates a computing device having an integrated wireless system for establishment of a wireless connection, in accordance with an example of the present subject matter,

FIG. 2 illustrates the computing device having the integrated wireless system for establishment of the wireless connection, in accordance with another example of the present subject matter,

FIG. 3 illustrates a method for establishing the wireless connection through the integrated wireless system in the computing device, in accordance with an example of the present subject matter, and

FIG. 4 illustrates a computing environment implementing a non-transitory computer-readable medium for establishing the wireless connection through the integrated wireless system of the computing device, in accordance with an example of the present subject matter.

### DETAILED DESCRIPTION

A wireless communication module is generally utilized by computing devices to facilitate wireless sharing of data with other devices. The wireless communication module generally includes one or more antennas along with integrated circuits, such as data encoders and decoders to facilitate communication conformant with different wireless standards. Further, the wireless communication module is generally embedded in a component housing that may house different components of a computing device. Accordingly, performance of such a wireless communication module is affected by the placement of the wireless communication module as well as the placement of the component housing. Generally, to conserve space around a user’s workspace, manufacturers try to reduce the size of the computing devices. To achieve reduced sizes, many computing devices are manufactured such that the component housing is placed inside closed cabinets or embedded at a rear end of a display panel of the computing device. Such a placement of the component housing may shield wireless signals, thereby reducing the overall coverage and throughput of the wireless communication module of the computing device.

According to examples of the present subject matter, computing devices comprising integrated wireless systems implementing techniques for establishment of wireless connections are described.

In an example, a computing device includes an integrated wireless system, where the integrated wireless system includes multiple wireless communication modules. The multiple wireless communication modules include a first wireless communication module housed outside of a component housing of the computing device and a second wireless communication module placed within the component housing. The computing device further comprises a switching engine that enables selection and utilization of a wireless communication module by switching between the first wireless communication module and the second wireless communication module based on Modulation and Coding Scheme (MCS) index of the first wireless communication module and the second wireless communication module.

In this manner, the throughput of the multiple wireless communication modules is monitored and a wireless communication module, from the first wireless communication module and the second wireless communication module, with higher throughput is selected for communication. Accordingly, the overall coverage and throughput associated with the wireless connection of the computing device is improved.

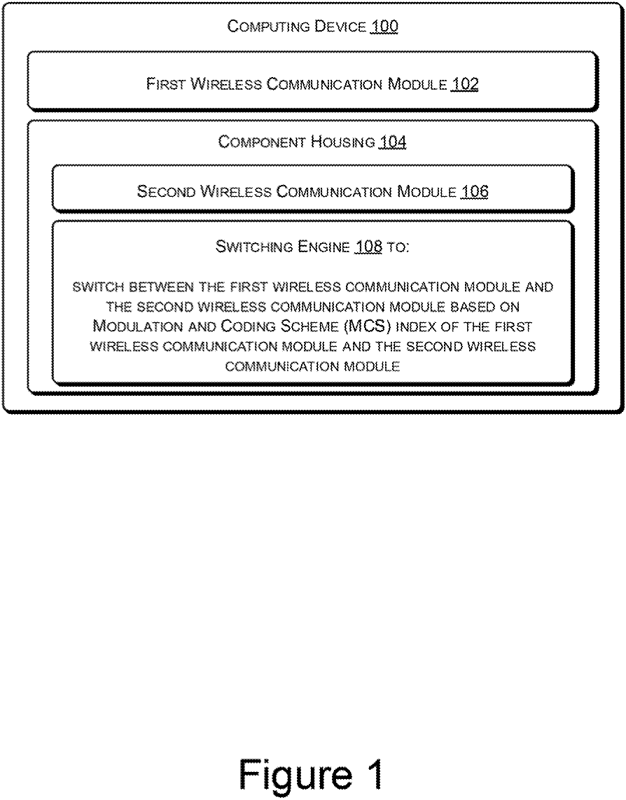

The above techniques are further described with reference to FIG. 1 to FIG. 4. It should be noted that the description and the figures merely illustrate the principles of the present subject matter along with examples described herein and should not be construed as a limitation to the present subject matter. It is, thus understood that various arrangements may be devised that although not explicitly described or shown herein, embody the principles of the present subject matter. Moreover, all statements herein reciting principles, aspects, and implementations of the present subject matter, as well as specific examples thereof, are intended to encompass equivalents thereof.

FIG. 1 illustrates a computing device 100 having an integrated wireless system for establishment of a wireless connection, in accordance with an example of the present subject matter. Examples of the computing device 100 may include, but are not limited to, laptops and desktops, such as all-in-one desktops.

According to an example of the present subject matter, the integrated wireless system of the computing device 100 may include a first wireless communication module 102 for establishing a wireless connection. A component housing 104 may further be included in the computing device 100, where the component housing 104 may be electronically coupled to the first wireless communication module 102.

The integrated wireless system may further include a second wireless communication module 106 for establishing the wireless connection. In an example, the second wireless communication module 106 may be housed within the component housing 104.

A switching engine 108 may further be included in the component housing 104, where the switching engine 108 may be electronically coupled to the first wireless communication module 102 and the second wireless communication module 106.

The integrated wireless system may facilitate communication at various frequencies, while conforming to different wireless communication standards, such as 802.11a, 802.11b, 802.11 g, 802.11n, 802.11ac, and 802.11ax.

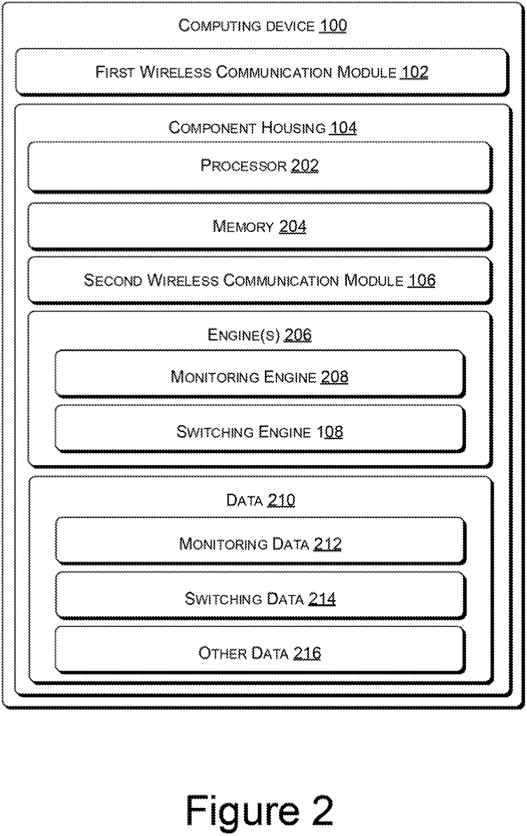

In operation, the switching engine 108 may select a wireless communication module between the first wireless communication module 102 and the second wireless communication module 106 for establishing the wireless connection and may utilize the wireless communication module for wireless communication. In an example, the switching engine 108 may select one of the first wireless communication module 102 and the second wireless communication module 106 based on respective data rates of the first wireless communication module 102 and the second wireless communication module 106. In said example, the data rates of the first wireless communication module 102 and the second wireless communication module 106 may be determined based on the respective Modulation and Coding Scheme (MCS) indexes. A detailed explanation of the computing device 100 is further provided with refence to an example implementation in reference to FIG. 2.

FIG. 2 illustrates the computing device 100 having the integrated wireless system for establishment of the wireless connection, in accordance with another example of the present subject matter.

In an example of the present subject matter, the computing device 100 may include the integrated wireless system having the first wireless communication module 102 and the second wireless communication module 106, and the component housing 104. Further, in an example, the first wireless communication module 102 may be housed outside the component housing 104 and the second wireless communication module 106 may be housed within the component housing 104. In addition to the second wireless communication module 106, the component housing 104 may also include a processor 202 and a memory 204 coupled to the processor 202. The functions of the various elements shown in the figures, including any functional blocks labelled as “processor(s)”, may be provided through the use of dedicated hardware as well as hardware capable of executing instructions. When provided by a processor, the functions may be provided by a single dedicated processor, by a single shared processor, or by a plurality of individual processors, some of which may be shared. Moreover, explicit use of the term “processor” would not be construed to refer exclusively to hardware capable of executing instructions, and may implicitly include, without limitation, digital signal processor (DSP) hardware, network processor, application specific integrated circuit (ASIC), field programmable gate array (FPGA). Other hardware, standard and/or custom, may also be coupled to processor 202.

The memory 204 may include any computer-readable medium including, for example, volatile memory (e.g., Random Access Memory (RAM)), and/or non-volatile memory (e.g., ROM, EPROM, flash memory, etc.).

Further, the computing device 100 may also include engine(s) 206, such as the switching engine 108 and a monitoring engine 208 coupled to the switching engine 108.

In an example, the engine(s) 206 may be implemented as a hardware, firmware and a combination thereof. In examples described herein, such combinations of hardware and firmware may be implemented in several different ways. For example, the firmware of the engine(s) may be processor executable instructions stored on a non-transitory machine-readable storage medium and the hardware for the engine may include a processing resource (for example, implemented as either a single processor or a combination of multiple processors), to execute such instructions.

In accordance to implementations of the present subject matter, the machine-readable storage medium may store instructions that, when executed by the processing resource, implement the functionalities of the engine(s). In such implementations, the computing device 100 may include the machine-readable storage medium for storing the instructions and the processing resource to execute the instructions.

In an example of the present subject matter, machine-readable storage medium may be located within the computing device 100. However, in other examples, the machine-readable storage medium may be located at a different location but accessible to computing device 100 and the processor 202.

The computing device 100 may further include data 210, that serves, amongst other things, as a repository for storing data that may be fetched, processed, received, or generated by the monitoring engine 208 and the switching engine 108. The data 210 may include monitoring data 212, switching data 214, and other data 216. In an example, the data 210 may be stored in the memory 204.

In an example of the present subject matter, the first wireless communication module 102 may be embedded in an input/ output (I/O) device of the computing device 100. For instance, the first wireless communication module 102 may be embedded on a display panel of the computing device 100, such as on the bezel of the display panel.

In an example, the computing device 100 may be an all-in-one desktop. An all-in-desktop may be referred to as a computing device having the display panel and the component housing coupled together. In such a situation, the component housing 104 may be coupled at a rear end of the display panel to form the all-in-one desktop. In said example, apart from the component housing 104, the first wireless communication module 102 may also be embedded on the display panel. In an example implementation, the first wireless communication module 102 may be embedded on the front end of the display panel, such as the bezel of the display panel.

It would be noted that while the aforementioned examples describe the first wireless communication module 102 to be embedded on the display panel, the first wireless communication module 102 may also be embedded on any other I/O device and/or peripheral device of the computing device 100, such as a speaker and a printer.

According to an example implementation of the present subject matter, the first wireless communication module 102 may be electronically coupled to the component housing 104 via an electronic bus. The electronic bus may include a peripheral component interconnect (PCI) bus, peripheral component interconnect express (PCle) bus, universal serial bus (USB), Mobile Industry Processor Interface (MIPI), or a combination thereof. Accordingly, the switching engine 108 may also be electronically coupled to the first wireless communication module 102 and the second wireless communication module 106 through such electronic bus. In other examples, coupling of the switching engine 108 with the first wireless communication module 102 and the second wireless communication module 106 may be facilitated by other known wired or wireless mechanisms, details of which have been omitted for the sake of brevity.

In operation, the monitoring engine 208 may monitor the MCS index of the first wireless communication module 102 and the second wireless communication module 106, where the MCS index indicates an available data rate of a wireless connection. It would be noted that the MCS index is computed based on the number of spatial streams being used in the wireless connection, modulation type, coding rate, channel bandwidth of a wireless communication module, and a guard interval.

It would be further noted that the modulation type in a wireless connection may be affected by various factors including, but not limited to, interference and line of sight. That is, a wireless communication module experiencing lesser interference may support more complex modulation types, thereby facilitating establishment of a wireless connection at higher data rates. Accordingly, a wireless communication module experiencing lesser noise may have a higher signal-to-noise ratio (SNR) and may have a higher MCS index.

In an example, the monitoring engine 208 may store the MCS index of each of the first wireless communication module 102 and the second wireless communication module 106 in the monitoring data 212. Subsequently, the monitoring engine 208 may compare the MCS index of the first wireless communication module 102 and the second wireless communication module 106. The monitoring engine 208 may compare the MCS index of the first wireless communication module 102 and the second wireless communication module 106 in predefined time intervals, after the computing device 100 is booted up.

In an example, the second wireless communication module 106 may be activated for establishment of the wireless connection when the computing device 100 is being booted. After the bootup of the computing device 100, the monitoring engine 208 may compare the MCS index of the first wireless communication module 102 and the second wireless communication module 106. Based on the comparison, the monitoring engine 208 may determine if the MCS index of the first wireless communication module 102 is higher than the MCS index of the second wireless communication module 106. Further, based on the determination, the monitoring engine 208 may determine if the wireless communication module being used for the wireless communication is to be switched and the second wireless communication module is to be utilized. That is, if it is determined that the MCS index of the first wireless communication module 102 is higher than the second wireless communication module 106, the monitoring engine 208 may notify the switching engine 108 to switch to the first wireless communication module for communication.

In an illustrative example, the second wireless communication module 106 may be active when the computing device 100 is being booted up. Upon boot up of the computing device 100, the monitoring engine 208 may monitor the MCS index of the second wireless communication module 106 and may determine it to have a value ‘2’. Further, the monitoring engine 208 may also determine the MCS index of the first wireless communication module 102 and may determine the value of it to be ‘4’.

It is possible that the MCS index of the first wireless communication module 102 may be higher (4) that the MCS index (2) of the second communication module 106 owing to lesser interference experienced by the first wireless communication module 102, thereby allowing usage of a more complex modulation type. Consequently, the first wireless communication module 102 may facilitate establishment of a wireless communication having higher data rate. The monitoring engine 208 may therefore send an input to the switching engine 108 to switch from the second wireless communication module 106 to the first wireless communication module 102 for wireless communication.

In another example, the monitoring engine 208 may compare the MCS index of the first wireless communication module 102 and the second wireless communication module 106 at predefined intervals of time. Accordingly, the monitoring engine 208 may provide an input to the switching engine 108 to select and utilize a wireless communication module between the first wireless communication module 102 and the second wireless communication module 106 for communication. Once the switching of the wireless communication modules is completed, the switching engine 108 may store a bit identifying the active communication module between the first wireless communication module 102 and the second wireless communication module 106 in the switching data 214.

In this manner, a wireless communication module providing higher data rate at an instant may be selected, thereby facilitating establishment of a wireless connection having higher throughput and wider coverage.

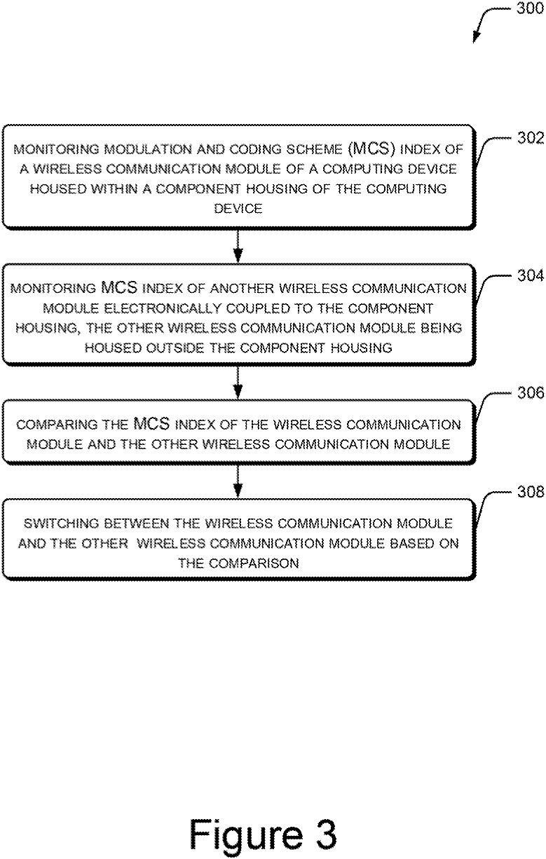

FIG. 3 illustrates a method for establishing a wireless connection through the integrated wireless system in the computing device, in accordance with an example of the present subject matter. Although the method 300 may be implemented in a variety of systems, but for the ease of explanation, the description of the method 300 is provided in reference to the above-described computing device 100. The order in which the method 300 is described is not intended to be construed as a limitation, and any number of the described method blocks may be combined in any order to implement the method 300, or an alternative method.

It may be understood that blocks of the method 300 may be performed in the computing device 100. The blocks of the methods 300 may be executed based on instructions stored in a non-transitory computer-readable medium, as will be readily understood. The non-transitory computer-readable medium may include, for example, digital memories, magnetic storage media, such as magnetic disks and magnetic tapes, hard drives, or optically readable digital data storage media.

At block 302, MCS index of a wireless communication module of the computing device may be monitored. In an example, the wireless communication module may correspond to the second wireless communication module 106 shown in FIG. 2. Accordingly, in said example, the wireless communication module may be housed within a component housing of the computing device. The MCS index of the wireless communication module may be monitored by the monitoring engine 208 of the computing device 100.

At block 304, MCS index of another wireless communication module of the computing device may be monitored. In an example, the other wireless communication module may correspond to the first wireless communication module 102 shown in FIG. 2. Accordingly, in said example, the other wireless communication module may be housed outside the component housing and may be electronically connected thereto. The MCS index of the other wireless communication module may also be monitored by the monitoring engine 208.

At block 306, the MCS index of the wireless communication module and the other wireless communication module may be compared. In an example, the MCS index may also be compared by the monitoring engine 208.

The MCS index of the wireless communication module and the other wireless communication module may be compared at multiple instances. For instance, the MCS index may be compared when the boot up of the computing device is finished. In another example, the MCS index may be compared at predefined intervals of time.

At block 308, based on the comparison, switching may be performed between the wireless communication module and the other wireless communication module. The switching may be performed to select the wireless communication module having higher MCS index and use the same to establish the wireless connection. In an example, the switching may be performed by the switching engine 108 of the computing device, based on an input from the monitoring engine 208.

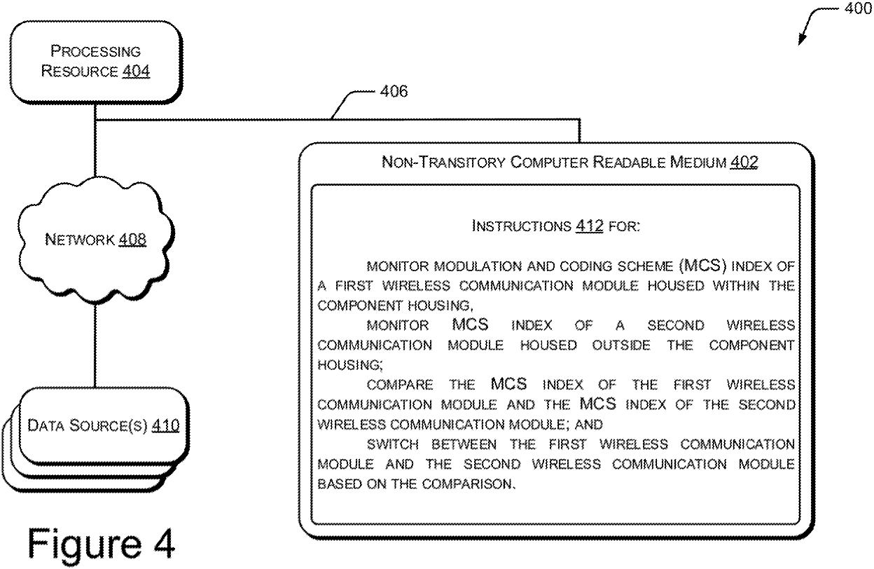

FIG. 4 illustrates a computing environment 400 implementing a non-transitory computer-readable medium 402 for establishing a wireless connection through the integrated wireless system of the computing device, in accordance with an example of the present subject matter. In an example implementation, the computing environment 400 may be a computing device, such as the computing device 100. The computing environment 400 includes a processing resource 404 communicatively coupled to the non-transitory computer-readable medium 402 through a communication link 406. In an example, the processing resource 404 fetches and executes computer-readable instructions from the non-transitory computer-readable medium 402.

The non-transitory computer-readable medium 402 can be, for example, an internal memory device or an external memory device. In an example implementation, the communication link 406 may be a direct communication link, such as any memory read/write interface. In another example implementation, the communication link 406 may be an indirect communication link, such as a network interface. In such a case, the processing resource 404 can access the non-transitory computer-readable medium 402 through a network 408. The network 408 may be a single network or a combination of multiple networks and may use a variety of different communication protocols.

The processing resource 404 and the non-transitory computer-readable medium 402 may also be communicatively coupled to data source(s) 410. The data source(s) 410 may be used to store data. In an example implementation, the non-transitory computer-readable medium 402 includes a set of computer-readable instructions for improving coverage and throughput associated with the wireless connection of the computing device, such as the computing device 100. The set of computer-readable instructions can be accessed by the processing resource 404 through the communication link 406 and subsequently executed to authorize the access to the computing device 100.

In an example, the non-transitory computer-readable medium 402 may include instructions for implementing a monitoring engine 208. The instructions implementing monitoring engine 208, in one example, may be a code executable to monitor and compare the MCS index of the first wireless communication module 102 and the second wireless communication module 106. In said example, the second wireless communication module 106 may be housed within the component housing 104 of the computing device 100 and the first wireless communication module 102 outside the component housing 104. Further, in said example, the component housing may further be embedded at a rear end of a display panel of the computing device 100.

The non-transitory computer-readable medium 402 may further include a set of instructions implementing a switching engine 108. The instructions implementing the switching engine 108, in one example, may be a code executable to switch and utilize a wireless communication module between the first wireless communication module 102 and the second wireless communication module 106 for establishment of the wireless connection.

In an example of the present subject matter, the instructions implementing the monitoring engine 208 may monitor the MCS index of the first wireless communication module 102 and the second wireless communication module 106. In said example, the MCS index of the first wireless communication module 102 and the second wireless communication module 106 may be monitored in parallel.

Further, the instructions implementing the monitoring engine 208 may compare the MCS index of the first wireless communication module 102 and the second wireless communication module 106. The instructions implementing the monitoring engine 208 may compare the MCS index at various instances. For instance, in one example, the MCS index may be compared when the boot up of the computing device 100 is finished. In another example, the MCS index may be compared regularly at predefined intervals of time.

Based on the comparison, the instructions implementing the switching engine 108 may switch and select a wireless communication module between the first wireless communication module 102 and the second wireless communication module 106 for establishment of the wireless connection. In an example, the switching engine 108 may switch between the first wireless communication module 102 and the second wireless communication module 106 to select and establish the wireless connection with the wireless communication module having higher MCS index.

In this manner, the instructions implementing the monitoring engine 208 and the switching engine 108 facilitates selection of the wireless communication module, from the first wireless communication module 102 and the second wireless communication module 106, having higher data rate, thereby facilitating establishment of a wireless connection having higher throughput and wider coverage.

Although examples of the present subject matter have been described in language specific to methods and/or structural features, it is to be understood that the present subject matter is not limited to the specific methods or features described. Rather, the methods and specific features are disclosed and explained as examples of the present subject matter.

We claim:

1. A computing device comprising:
a first wireless communication module housed outside a component housing of the computing device;
a second wireless communication module housed within the component housing; and
a switching engine coupled to the first wireless communication module and the second wireless communication module, wherein the switching engine is to switch between the first wireless communication module and the second wireless communication module based on Modulation and Coding Scheme (MCS) index of the first wireless communication module and the second wireless communication module.

2. The computing device as claimed in claim 1, wherein the first wireless communication module is embedded in an I/O device of the computing device.

3. The computing device as claimed in claim 2, wherein the I/O device is a display panel, and wherein the first wireless communication module is embedded at a front end of the display panel.

4. The computing device as claimed in claim 3, wherein the first wireless communication module is embedded on a bezel of the display panel.

5. The computing device as claimed in claim 2, wherein the component housing and the first wireless communication module are embedded at a rear end of the display panel.

6. The computing device as claimed in claim 1, wherein the first wireless communication module is coupled to the component housing via a peripheral component interconnect (PCI) bus, peripheral component interconnect express (PCIe) bus, universal serial bus (USB), and Mobile Industry Processor Interface (MIPI), or a combination thereof.

7. A method comprising:
monitoring a Modulation and Coding Scheme (MCS) index of a wireless communication module of a computing device housed within a component housing of the computing device;
monitoring an MCS index of another wireless communication module electronically coupled to the component housing, the other wireless communication module being housed outside the component housing;
comparing the MCS index of the wireless communication module and the other wireless communication module; and
switching between the wireless communication module and the other wireless communication module based on the comparison.

8. The method as claimed in claim 7, wherein the switching comprises selecting one of the wireless communication module and the other wireless communication module based on a higher MCS index.

9. The method as claimed in claim 8, wherein the MCS index of the wireless communication module changes based on a signal-to-noise ratio (SNR) of the wireless communication module and the MCS index of the other wireless communication module changes based on an SNR of the other wireless communication module.

10. The method as claimed in claim 7, wherein the method comprises comparing the MCS index of the wireless communication module and the other wireless communication module after bootup of the computing device.

11. The method as claimed in claim 7, wherein the method comprises comparing the MCS index of the wireless communication module and the other wireless communication module at predefined intervals of time.

12. A non-transitory computer-readable medium comprising instructions executable by a processing resource to:
monitor a Modulation and Coding Scheme (MCS) index of a first wireless communication module housed outside a component housing of a computing device, wherein the component housing is embedded at a rear end of a display panel of the computing device;
monitor an MCS index of a second wireless communication module housed within the component housing;
compare the MCS index of the first wireless communication module and the MCS index of the second wireless communication module; and
switch between the first wireless communication module and the second wireless communication module based on the comparison.

13. The non-transitory computer-readable medium as claimed in claim 12, further comprising instructions to monitor the MCS index of the first wireless communication module and the second wireless communication module after bootup of the computing device.

14. The non-transitory computer-readable medium as claimed in claim 12, further comprising instructions to monitor the MCS index of the first wireless communication module and the second wireless communication module at predefined intervals of time.

15. The non-transitory computer-readable medium as claimed in claim 12, further comprising instructions to select one of the first wireless communication module and the second wireless communication module based on higher MCS index.
